(19) United States
(12) Patent Application Publication
(10) Pub. No.: US 2022/0219620 A1
(43) Pub. Date: Jul. 14, 2022

(54) A VEHICLE CAMERA DEVICE

(71) Applicant: VEONEER SWEDEN AB, VARGARDA (SE)

(72) Inventors: MADELEINE PERSSON, LINKÖPING (SE); MAGNUS STARK, LINKÖPING (SE); GUSTAV ALM, LINKÖPING (SE); FREDRIK GREN, LINKÖPING (SE)

(73) Assignee: VEONEER SWEDEN AB, VARGARDA (SE)

(21) Appl. No.: 17/613,204

(22) PCT Filed: May 19, 2020
(86) PCT No.: PCT/EP2020/064014

§ 371 Date: Nov. 22, 2021

(30) Foreign Application Priority Data
May 23, 2019 (EP) 19176098.2

(51) Int. Cl. B60R 11/04; G03B 11/04; H04N 5/225

(52) U.S. Cl. CPC B60R 11/04; G03B 11/045; B60R 2011/0026; H04N 5/2252; H04N 5/2254

(57) ABSTRACT

A camera device (1) that having a light-trap arrangement (2) and a camera housing (3) with a lens assembly (4). When mounted to the camera housing (3), the light-trap arrangement (2) is intended to limit light incoming toward the lens assembly (4), and the camera device (1) is intended to be mounted to a mounting bracket (5) positioned inside a vehicle (6). The camera housing (3) has at least one housing holding part (7A, 8A, 9A, 10A) and the light-trap arrangement includes at least one corresponding light-trap holding part (7B, 8B, 9B, 10B). Corresponding holding parts (7A, 7B; 8A, 8B; 9A, 9B; 10A, 10B) are adapted to be brought into an engaging holding position when the light-trap arrangement (2) is attached to the camera housing (3).

### CROSS-REFERENCE TO RELATED APPLICATIONS

This application is a 35 U.S.C. § 371 national phase of PCT International Application No. PCT/EP2020/064014, filed May 19, 2020, which claims the benefit of priority under 35 U.S.C. § 119 to European Patent Application No. 19176098.2, filed May 23, 2019, the contents of which are incorporated herein by reference in their entirety.

### SUMMARY OF THE INVENTION

The present disclosure relates to a camera device that includes a light-trap arrangement and a camera housing with a lens assembly. When mounted to the camera housing, the light-trap arrangement is intended to limit light incoming toward the lens assembly.

### BACKGROUND

Many vehicle environment detection systems comprise one or more sensors such as for example radar sensor, LIDAR sensors, camera devices and ultrasonic sensors. These are used for collecting data used for safety arrangements as well as for driver assistance systems.

Regarding camera devices, these are often fastened to a mounting bracket that is fastened to an interior part of the vehicle, such as the windshield as described in U.S. Pat. No. 10,173,608 B2 and US 2018/0154842 A1. In these documents, the mounting bracket is integrated with a light-trap arrangement that is adapted to limit incoming light. US 2018/0015260 A1 discloses a separate light-trap arrangement that is fastened to a camera device by use of an adhesive, and after that the resulting camera device is attached to a mounting bracket.

It is an object of the present disclosure to provide a camera device that is more versatile and effective during assembly as well as a corresponding assembly method.

### SUMMARY

The above-referenced object is achieved by embodiments of the present invention, in the form of a camera device that intended to be mounted to a mounting bracket positioned inside a vehicle and includes a light-trap arrangement and a camera housing with a lens assembly. When mounted to the camera housing, the light-trap arrangement is intended to limit light incoming toward the lens assembly. The camera housing includes at least one housing holding part and the light-trap arrangement includes at least one corresponding light-trap holding part. Corresponding holding parts are adapted to be brought into an engaging holding position when the light-trap arrangement is attached to the camera housing.

In this way, a versatile and effective assembly is enabled.

According to some aspects of embodiments of the present invention, corresponding holding parts are adapted for releasable engagement.

This means that the parts can be easily separated, for example for service or parts change.

According to some aspects of embodiments of the present invention, for at least one pair of corresponding holding parts, a first holding part is resilient and a second holding part is fixed. The first holding part is adapted to snap into a locking position in engagement with the second holding part.

According to some aspects of embodiments of the present invention, the light-trap arrangement includes two light-trap front holding parts, each having a resilient hook with a protruding part. The camera housing has two housing front holding parts, each including a fixed indent part. Each hook is adapted to embrace a corresponding indent part such that each protruding part locks against a corresponding indent part.

In this manner, a secure front locking is enabled.

According to some aspects of embodiments of the present invention, the light-trap arrangement includes two light-trap rear holding parts, each having a resilient angled tongue part. Furthermore, the camera housing has two housing rear holding parts, each including a fixed indent part. Each tongue part is adapted to engage a corresponding indent part such that the corresponding tongue part locks against the corresponding indent part.

In this manner, a secure rear locking is enabled.

The above-described object is also achieved through of a method that is associated with the above advantages.

In particular, the object is also achieved by a method for mounting a light-trap arrangement to a camera housing with a lens assembly. When mounted to the housing, the light-trap arrangement is used for limiting light incoming toward the lens assembly. The housing is intended to be mounted to a mounting bracket positioned inside a vehicle. The method includes the step of bringing at least one rear holding part included in the light trap arrangement in engagement with at least one corresponding receiving rear holding part included in the housing. The method further includes bringing at least one front holding part included in the light trap arrangement in engagement with at least one corresponding receiving front holding part included in the housing.

### BRIEF DESCRIPTION OF THE DRAWINGS

The present disclosure will now be described more in detail with reference to the appended drawings, where:

FIG. 1 shows a schematic cut-open part of a vehicle with a camera device;

FIG. 2 shows a schematic top perspective view of a light trap arrangement;

FIG. 3 shows a schematic bottom perspective view of the light trap arrangement;

FIG. 4 shows a schematic perspective view of a light trap arrangement, a camera housing and a mounting bracket;

FIG. 5 shows a schematic perspective view of a light trap arrangement mounted to a camera housing;

FIG. 6 shows a schematic top view of a light trap arrangement mounted to a camera housing;

FIG. 7 shows a schematic first section side view of a light trap arrangement mounted to a camera housing;

FIG. 8 shows a schematic second section side view of a light trap arrangement mounted to a camera housing; and

FIG. 9 shows a flowchart for a method according to the present disclosure.

### DETAILED DESCRIPTION

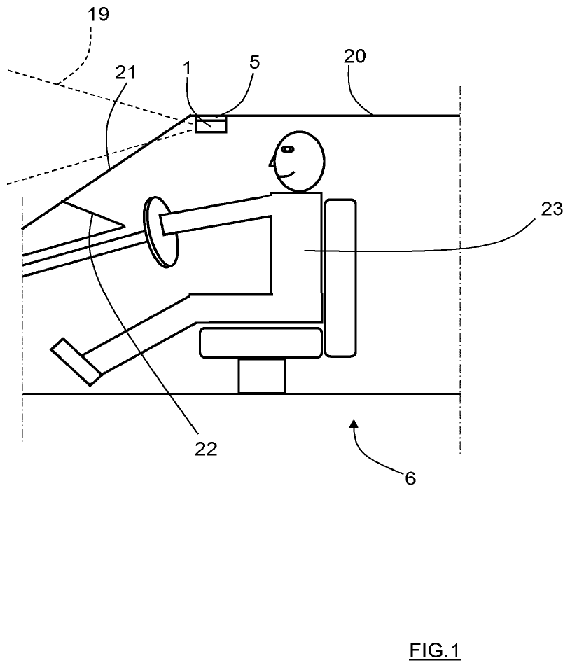

FIG. 1 schematically shows a cut-open part of a vehicle 6, where the vehicle 6 includes a digital camera device 1. The digital camera device 1 is arranged for capturing images of the surroundings outside the vehicle 6 through a certain field of view 19. A digital camera device 1 can also, or alternatively, be arranged for capturing images of a driver 23, where these images, which may include eye movements, for example can be used for detecting a degree of driver drowsiness.

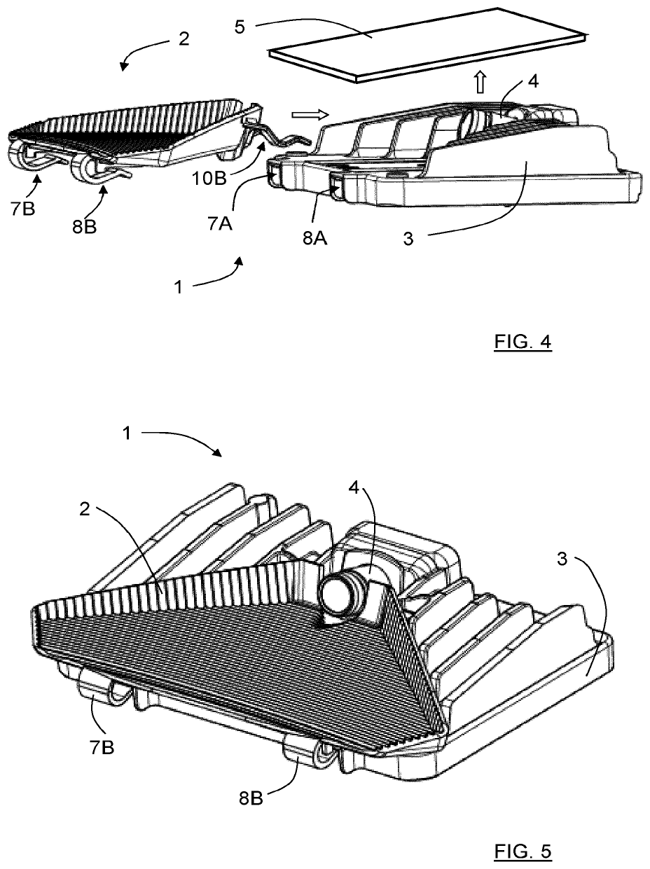

With reference also to FIG. 4, a digital camera device 1 is normally mounted to a mounting bracket 5 (only schematically indicated) positioned inside the vehicle 6, and includes a light-trap arrangement 2 and a camera housing 3 with a lens assembly 4. When mounted to the camera housing 3, the light-trap arrangement 2 is intended to limit light incoming toward the lens assembly 4.

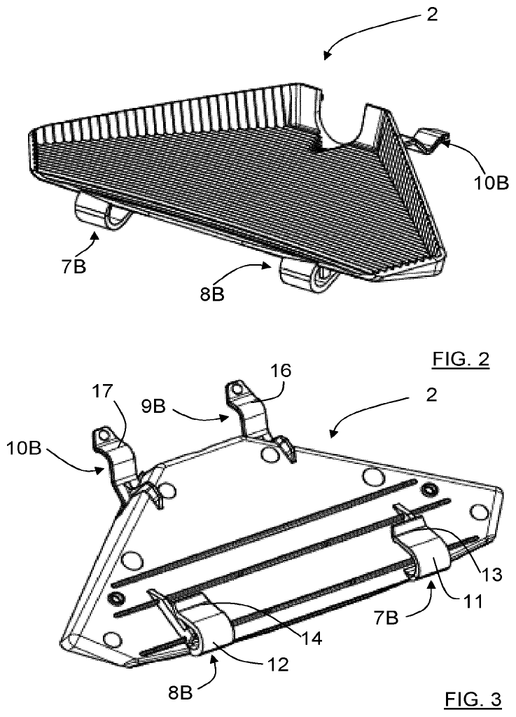

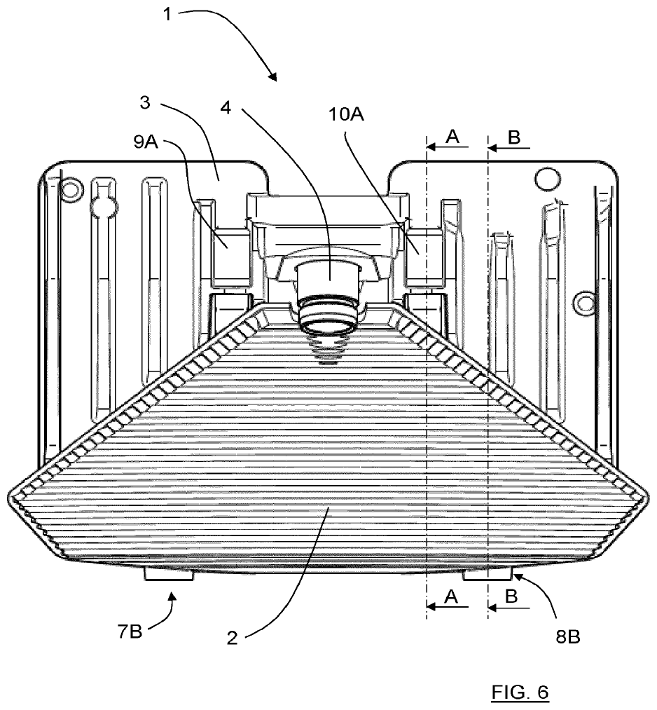

Throughout assembly of the camera device 1, it is desired that the mounting is efficient and uncomplicated. Therefore, according to the present disclosure and with reference also to FIG. 2-3 and FIG. 5-8, the camera housing 3 includes four housing holding parts 7A, 8A, 9A, 10A and the light-trap arrangement 2 includes four corresponding light-trap holding part 7B, 8B, 9B, 10B. Corresponding holding parts 7A, 7B; 8A, 8B; 9A, 9B; 10A, 10B are adapted to be brought into an engaging holding position when the light-trap arrangement 2 is attached to the camera housing 3.

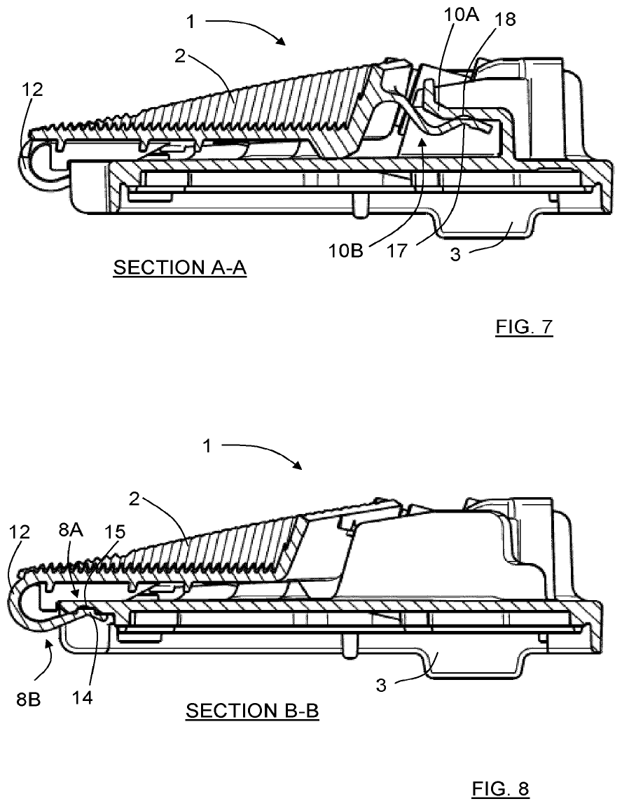

More in detail, according to some aspects in a first example, the light-trap arrangement 2 includes two light-trap rear holding parts 9B, 10B, each including a resilient angled tongue part 16, 17. The camera housing 3 includes two housing rear holding parts 9A, 10A, each including a fixed indent part 18. Each tongue part 17 is adapted to engage a corresponding indent part 18 such that the corresponding tongue part 17 locks against the corresponding indent part 18 as in particular shown in FIG. 7.

According to some further aspects of embodiments of the present invention, the light-trap arrangement 2 includes two light-trap front holding parts 7B, 8B, each including a resilient hook 11, 12 with a protruding part 13, 14. The camera housing 3 includes two housing front holding parts 7A, 8A, each including a fixed indent part 15. Each hook 12 is adapted to embrace a corresponding indent part 15 such that each protruding part 14 locks against a corresponding indent part 15 as in particular shown in FIG. 8.

Many other types of holding parts are of course conceivable, where, in a pair of holding parts that are adapted for mutual engagement, according to some aspects, such a pair includes a resilient holding part and a fixed holding part, or two resilient holding parts. One holding part, or both holding parts, can have a locking function relative the other holding part.

How these different types of holding parts are distributed and arranged at the camera housing 2 and the light-trap arrangement 2 can of course be varied in many ways. The camera housing 3 includes at least one housing holding part 7A, 8A, 9A, 10A and the light-trap arrangement includes at least one corresponding light-trap holding part 7B, 8B, 9B, 10B. Corresponding holding parts 7A, 7B; 8A, 8B; 9A, 9B; 10A, 10B are adapted to be brought into an engaging holding position when the light-trap arrangement 2 is attached to the camera housing 3.

According to some aspects of embodiments of the present invention, corresponding holding parts 7A, 7B; 8A, 8B; 9A, 9B; 10A, 10B are adapted for releasable engagement.

According to some aspects of embodiments of the present invention, for at least one pair of corresponding holding parts 7A, 7B; 8A, 8B; 9A, 9B; 10A, 10B, a first holding part 7B, 8B, 9B, 10B is resilient and a second holding part 7A, 8A, 9A, 10A is fixed, where the first holding part 7B, 8B, 9B, 10B is adapted to snap into a locking position in engagement with the second holding part 7A, 8A, 9A, 10A. Resilient holding parts can be positioned at the light-trap arrangement 2, the camera housing 3, or both. Fixed holding parts can also be positioned at the light-trap arrangement 2, the camera housing 3, or both.

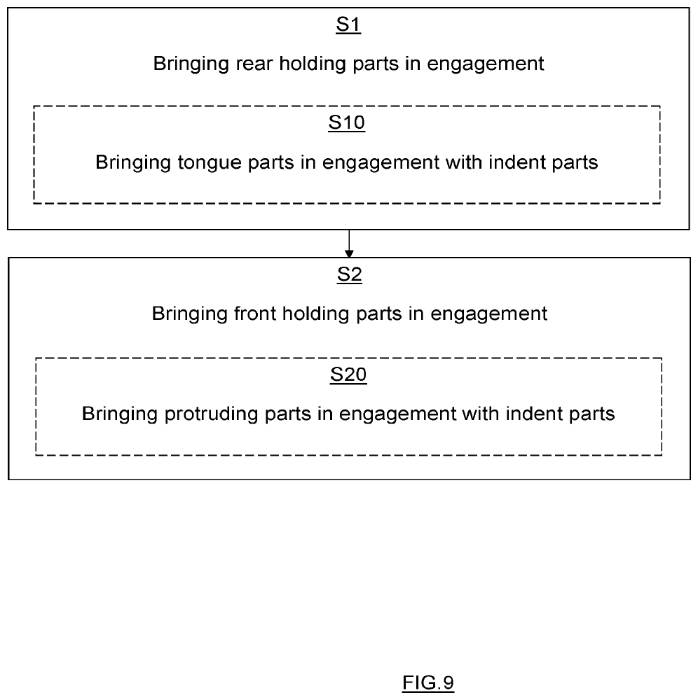

With reference to also to FIG. 9, the present disclosure relates to a method for mounting a light-trap arrangement 2 to a camera housing 3 with a lens assembly 4, where, when mounted to the housing 3, the light-trap arrangement 2 is used for limiting light incoming toward the lens assembly 4. The housing 3 is intended to be mounted to a mounting bracket 5 positioned inside a vehicle 6. The method includes bringing S1 at least one rear holding parts 9B, 10B included in the light trap arrangement 2 in engagement with at least one corresponding receiving rear holding part 9A, 10A included in the housing 3. The method also includes bringing S2 at least one front holding part 7B, 8B included in the light trap arrangement 2 in engagement with at least one corresponding receiving front holding part 7A, 8A included in the housing 3.

According to some aspects of embodiments of the present invention, the method further includes bringing S10 resilient angled tongue parts 16, 17 included in the light trap arrangement 2 in engagement with corresponding receiving fixed indent parts 18 included in the housing 3. The method also includes bringing S20 resilient hooks 11, 12 having protruding parts 13, 14 and being included in the light trap arrangement 2 in engagement with corresponding receiving fixed indent parts 14 included in the housing 3 such that each hook 12 is embracing the corresponding indent part 14, and such that the corresponding protruding part 14 is locking against the corresponding indent part 15.

By means of the present disclosure, the light trap arrangement 2 can be mounted to the camera housing 3 in a quick and reliable manner, and these assembled parts can later be mounted to the bracket 5 in a quick and reliable manner.

The present disclosure is not limited to the examples above, but may vary freely within the scope of the appended claims. For example, it is evident that there can be many different types of holding parts that work in different ways that can be sued for the present disclosure.

With reference to FIG. 1, the digital camera device 1 may be of any suitable kind, and may be placed in any suitable position in the vehicle 6, for example at the ceiling 20, windshield 21 or the dashboard 22. Other examples are airbag covers.

According to some aspects of embodiments of the present invention, the digital camera device 1 includes a power assembly, an interface assembly and a control unit, which all are positioned at and/or within the camera housing.

According to some aspects of embodiments of the present invention, the camera housing 3 includes several sub-parts, for example an upper part and a lower part.

According to some aspects of embodiments of the present invention, the light-trap arrangement 2 is made in a plastic material. According to some aspects, the camera housing 3 is made in a plastic material.

Generally, the present disclosure relates to a camera device 1 that includes a light-trap arrangement 2 and a camera housing 3 with a lens assembly 4, where, when mounted to the camera housing 3, the light-trap arrangement 2 is intended to limit light incoming toward the lens assembly 4, where the camera device 1 is intended to be mounted to a mounting bracket 5 positioned inside a vehicle 6. The camera housing 3 includes at least one housing holding part 7A, 8A, 9A, 10A and the light-trap arrangement includes at least one corresponding light-trap holding part 7B, 8B, 9B, 10B, where corresponding holding parts 7A, 7B; 8A, 8B; 9A, 9B; 10A, 10B are adapted to be brought into an engaging holding position when the light-trap arrangement 2 is attached to the camera housing 3.

According to some aspects of embodiments of the present invention, corresponding holding parts 7A, 7B; 8A, 8B; 9A, 9B; 10A, 10B are adapted for releasable engagement.

According to some aspects of embodiments of the present invention, for at least one pair of corresponding holding parts 7A, 7B; 8A, 8B; 9A, 9B; 10A, 10B, a first holding part 7B, 8B, 9B, 10B is resilient and a second holding part 7A, 8A, 9A, 10A is fixed, where the first holding part 7B, 8B, 9B, 10B is adapted to snap into a locking position in engagement with the second holding part 7A, 8A, 9A, 10A.

According to some aspects of embodiments of the present invention, the light-trap arrangement includes two light-trap front holding parts 7B, 8B, each including a resilient hook 11, 12 with a protruding part 13, 14, and where the camera housing 3 includes two housing front holding parts 7A, 8A, each including a fixed indent part 15, where each hook 12 is adapted to embrace a corresponding indent part 15 such that each protruding part 14 locks against a corresponding indent part 15.

According to some aspects of embodiments of the present invention, the light-trap arrangement 2 includes two light-trap rear holding parts 9B, 10B, each including a resilient angled tongue part 16, 17, and where the camera housing 3 includes two housing rear holding parts 9A, 10A, each including a fixed indent part 18, where each tongue part 17 is adapted to engage a corresponding indent part 18 such that the corresponding tongue part 17 locks against the corresponding indent part 18.

While the above description constitutes the preferred embodiment of the present invention, it will be appreciated that the invention is susceptible to modification, variation and change without departing from the proper scope and fair meaning of the accompanying claims.

1. A camera device intended to be mounted to a mounting bracket positioned inside a vehicle comprising, a light-trap arrangement and a camera housing with a lens assembly, where, when mounted to the camera housing, the light-trap arrangement functions to limit light incoming toward the lens assembly, the camera housing comprises at least one housing holding part and the light-trap arrangement comprises at least one corresponding light-trap holding part, where corresponding ones of the housing and the light trap holding parts are adapted to be brought into an engaging holding position when the light-trap arrangement is attached to the camera housing.

2. The camera device according to claim 1, wherein the corresponding ones of the housing and the light trap holding parts are adapted for releasable engagement.

3. The camera device according to claim 1, wherein, for at least one pair of the corresponding ones of the housing and the light trap holding parts, a first of the light trap holding parts is resilient and a second of the housing holding parts is fixed, where the first holding part is adapted to snap into a locking position in engagement with the second holding part.

4. The camera device according to claim 2, wherein the light-trap arrangement comprises two of the light-trap holding parts in the form of light-trap front holding parts, each comprising a resilient hook with a protruding part, and where the camera housing comprises two of the housing holding parts in the form of housing front holding parts, each comprising a fixed indent part, where each of the hooks is adapted to embrace a corresponding of the indent parts such that each of the protruding parts locks against a corresponding of the indent parts.

5. The camera device according to claim 2, wherein the light-trap arrangement comprises two light-trap holding parts in the form of light-trap rear holding parts, each comprising a resilient angled tongue part, and where the camera housing comprises two of the housing holding parts in the form of housing rear holding parts, each comprising a fixed indent part, where each of the tongue parts is adapted to engage the corresponding of the indent parts such that the corresponding tongue part locks against the corresponding indent part.

6. A method for mounting a light-trap arrangement to a camera housing with a lens assembly, where, when mounted to the housing, the light-trap arrangement is used for limiting light incoming toward the lens assembly, where the housing is intended to be mounted to a mounting bracket positioned inside a vehicle, comprising the steps of:
bringing at least one rear holding parts included in the light trap arrangement in engagement with at least one corresponding receiving rear holding part included in the housing; and
bringing at least one front holding part included in the light trap arrangement in engagement with at least one corresponding receiving front holding part included in the housing.

7. The method according to claim 6, wherein the method further comprises the steps of:
bringing resilient angled tongue parts included in the light trap arrangement in engagement with corresponding receiving fixed indent parts included in the housing; and
bringing resilient hooks having protruding parts and being included in the light trap arrangement in engagement with corresponding receiving fixed indent parts included in the housing such that each hook is embracing the corresponding indent part, and such that the corresponding protruding part is locking against the corresponding indent part.
